(19) United States
(12) Patent Application Publication
(10) Pub. No.: US 2001/0035374 A1
(43) Pub. Date: Nov. 1, 2001

(54) Hollow fiber separation membrane element, hollow fiber separation membrane module, and process for producing the same

(75) Inventors: Tatuo Yamamoto, Osaka (JP); Mituo Maeda, Yamaguchi (JP)

Correspondence Address: YOUNG & THOMPSON, 745 SOUTH 23RD STREET 2ND FLOOR, ARLINGTON, VA, 22202

(73) Assignee: Ube Industries, Ltd.

(21) Appl. No.: 09/839,117

(22) Filed: Apr. 23, 2001

(30) Foreign Application Priority Data
Apr. 26, 2000 (JP) 2000-125586

(51) Int. Cl. B01D 63/02; B01D 63/10; B01D 67/00; B01D 69/08

(52) U.S. Cl. 210/321.8; 210/321.79; 210/321.88; 210/321.89; 210/500.23

(57) ABSTRACT

A hollow fiber separation membrane element and a module thereof which comprise a bundle of a great number of bunches of hollow fiber separation membranes, the bunches of hollow fiber separation membranes being each reinforced with a filament wound therearound. Breakage or rupture of the hollow fiber separation membranes is prevented during production and use.

### BACKGROUND OF THE INVENTION

1. Field of the Invention

The present invention relates to a hollow fiber separation membrane element and a hollow fiber separation membrane module which are used to separate and purify gas or liquid and to a process for producing them. More particularly, it relates to a hollow fiber separation membrane element and a hollow fiber separation membrane module which can be produced easily even with brittle hollow fiber separation membranes and which have improved durability and to a process for producing them.

2. Description of the Related Art

Hollow fiber separation membrane elements are mostly composed of a bundle of several hundreds to several hundred of thousands of hollow fibers of small thickness and small diameter having selective permeability, one or both ends of which being fixed with a cured resin, such as an epoxy resin, with the ends of each hollow fiber open. Hollow fiber separation membrane modules comprise the hollow fiber separation membrane element fitted into a container having at least a mixture feed inlet, a permeate discharge outlet, and a residue discharge outlet, wherein the space leading to the inside of the hollow fibers and the space leading to the outside of the hollow fibers are isolated.

A process of producing such a hollow fiber separation membrane element usually comprises the steps of bundling the hollow fibers, adhering the end(s) of the hollow fiber bundle with a resin, and machining the adhered end(s) to expose the openings of the hollow fibers and to regulate the size.

In the step of bundling, a predetermined number of the hollow fibers are gathered by a bundling machine having a reciprocating traverse guide, or the hollow fiber is reeled on a reeling machine to a prescribed number of turns to form a hollow fiber bundle. In the step of adhering, the end of the hollow fiber bundle is impregnated with an epoxy resin, etc. followed by heating to cure the resin. In the step of machining, the adhered and fixed end of the hollow fiber bundle is machined by, for example, cutting to provide a hollow fiber element having a predetermined length with every fiber open at one or both ends.

The module is produced by putting the hollow fiber separation membrane element in a container in the form of a straight line, a U-shape, a helix, etc. and fixed by adhesion or screwing while isolating the space leading to the inside of the hollow fibers and the space leading to the outside of the hollow fibers from each other.

The hollow fibers are subject to deformation, such as pulling or bending, when handled in each of the above-mentioned steps of production. Where the hollow fiber separation membrane has a small elongation and easily breaks, it is liable to breakage or rupture in these steps, and it has been difficult to obtain separation membrane elements or modules stably.

During use, too, a hollow fiber separation membrane is susceptible to continuous or discontinuous deforming stresses due to the viscosities, flow rates, flow velocities, pressures and temperatures of the fluids flowing inside and outside of the membrane and variations of these factors. Where the hollow fiber separation membrane has a small elongation and breaks easily, it has poor durability, tending to break or rupture during use.

From the aspect of material, various studies have been conducted aiming at improvement of separation performance. Materials of separation membranes heretofore proposed include ceramic materials (see Japanese Patent Laid-Open Nos. 63-291809 and 8-318141), carbon materials (see Japanese Patent Laid-Open No. 60-179102), partially carbonized polymers (see Japanese Patent Laid-Open No. 4-11933), rigid polymers, such as cardo polyimide (see Japanese Patent Laid-Open No. 8-332362), and composites comprising these materials (see Japanese Patent Laid-Open No. 10-52629).

However, most of these materials have a small elongation and break so easily that it has been difficult to produce hollow fiber separation membrane elements or modules in which hollow fibers have a thin wall and a small diameter. Such hollow fiber separation membrane elements or modules have, of necessity, poor durability, having liability to breakage or rupture during use.

To overcome this problem, Japanese Patent Laid-Open No. 5-220360 proposes a hollow fiber separation membrane made of partially carbonized aromatic polyimide, in which the degree of carbonization is controlled so that the separation membrane may have an improved elongation not to break or rupture easily when bent. Even with this improved hollow fiber membrane, there still remains much room for improvement on resistance against breakage and rupture during production and on durability in use.

### SUMMARY OF THE INVENTION

An object of the present invention is to provide a hollow fiber separation membrane element and a module thereof which are produced with ease even by using hollow fiber separation membranes that are easily broken due to a small elongation and which have improved durability and a process for producing the same.

The object of the present invention is accomplished by:

A hollow fiber separation membrane element comprising a bundle of a great number of bunches of hollow fiber separation membranes, the bunches of hollow fiber separation membranes being reinforced with a filament wound therearound, and a tubesheet provided at one or both ends of the bundle;

A hollow fiber separation membrane module comprising at least one hollow fiber separation membrane element having the above structure which is fitted into a container having at least a mixture feed inlet, a permeate discharge outlet, and a residue discharge outlet; and

A process of producing a hollow fiber separation membrane element and a hollow fiber separation membrane module, which comprises the steps of winding a filament around a bunch of hollow fiber separation membranes to prepare reinforced hollow fiber bunches and bundling a great number of the reinforced hollow fiber bunches.

The hollow fiber separation membrane element and the module thereof according to the present invention are produced easily even with hollow fiber separation membranes which have a small elongation and break easily. Reinforced with a filament, the hollow fiber separation membranes have improved durability, being prevented from breakage or rupture during production and use.

### BRIEF DESCRIPTION OF THE DRAWINGS

The present invention will be more particularly described with reference to the accompanying drawings, in which:

FIG. 1 schematically shows an embodiment of the hollow fiber bunch used in the present invention;

FIG. 2 schematically illustrates an embodiment of the hollow fiber separation membrane element according to the present invention;

FIG. 3 is a schematic vertical cross-section of an embodiment of the hollow fiber separation membrane module according to the present invention;

FIG. 4 is a schematic vertical cross-section of another embodiment of the hollow fiber separation membrane module according to the present invention; and

FIG. 5 schematically shows a method for helically winding a filament around a plurality of hollow fiber separation membranes.

### DETAILED DESCRIPTION OF THE INVENTION

The hollow fiber separation membrane element of the present invention comprises a bundle of a great number of bunches of hollow fiber separation membranes, the bunches of hollow fiber separation membranes being reinforced with a filament wound therearound, and a tubesheet provided at one or both ends of the bundle. The bunch of hollow fiber separation membranes will be referred to as a hollow fiber bunch (A), and the bundle of the hollow fiber bunches (A) will be referred to as a hollow fiber bundle (B).

The language “reinforced with a filament wound therearound” is intended to means that a filament is wound around a plurality of hollow fiber separation membranes grouped substantially in parallel to fasten them together into a bunch and to make them stronger. The hollow fiber separation membranes do not need to be fastened tightly so that the membranes have some freedom of movement in the parts having no filament therearound.

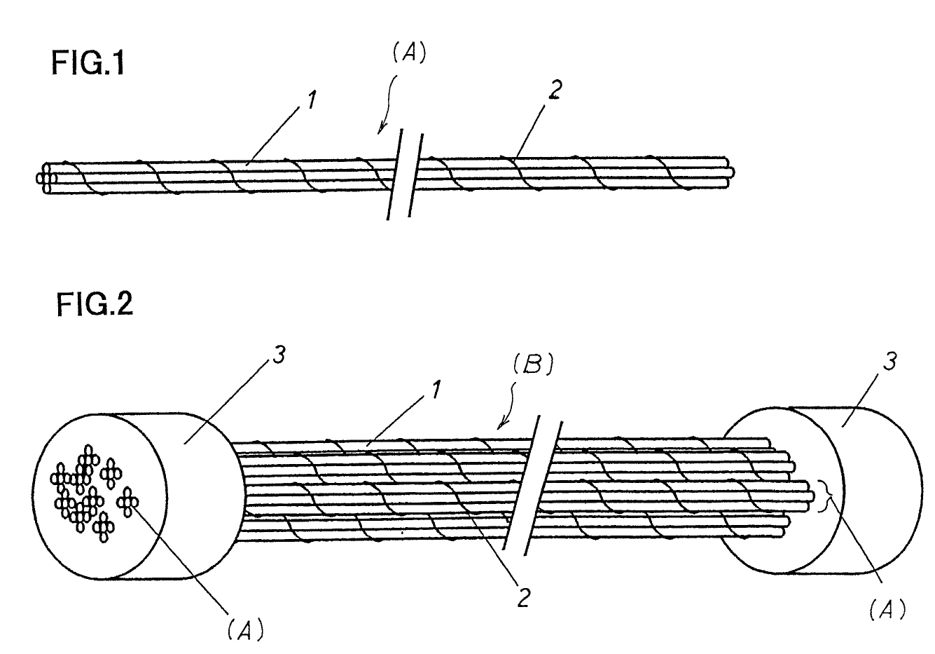

The pattern of winding is not particularly restricted. The filament can be tied around the bunch of hollow fibers discontinuously at a certain interval or continuously wound around the bunch in a helix (helical winding). Helical winding is preferred for suitability to continuous production and for reinforcing effect (the filament per se experts a reinforcing effect, in addition to the reinforcing effect of hollow fiber separation membranes wound around by the filament). FIG. 1 schematically shows an example of the hollow fiber bunch (A) composed of five hollow fiber separation membranes 1 reinforced by a filament 2 helically wound therearound. One or more than one filaments 1 can be used for winding.

The manner of winding is preferably such that the pitch is 2 to 1000 times, particularly 10 to 300 time, as long as the outer diameter of the filament. Close winding at a pitch less than twice the outer diameter of the filament not only results in a false economy, needing a large amount of the filament, but fastens the hollow fiber bunch (A) tightly to increase the contact area among the hollow fibers thereby to decrease the effective membrane area for producing the separating function. Sparse winding at a pitch exceeding 1000 times the outer diameter of the filament gives only limited restraint to the hollow fiber bunch (A), and the reinforcing effect would be reduced.

While not limiting, the outer diameter of the filament is preferably 50 to 300 μm, still preferably 50 to 150 μm. Filaments having an outer diameter more than 300 μm will is increase the dead space of the hollow fiber bundle (B) to decrease the fiber packing density of the separation membrane element, which results in reduction of the separation efficiency of the separation membrane element or module. The fiber packing density is represented by the ratio of the total cross-sectional area of the individual hollow fiber separation membranes making up the separation membrane element to the cross-sectional area of the separation membrane element. Since the filament also serves as a spacer among the hollow fiber bunches (A), the outer diameter of the filament is selected so as to adjust the space among the bunches (A) appropriately.

It is preferred for the filament to have a tensile strength, represented in terms of tensile strength at break (hereinafter the same), of 100 gf/filament or more, particularly 200 gf/filament or more, and a tensile elongation at break of 10% or more. A filament having a tensile strength less than 100 gf/filament or an elongation at break less than 10% tends to be difficult to wind or, if successfully wound, tends to be too brittle to produce sufficient reinforcing effect.

The filament is suitably made of natural fibers such as cotton fiber and wool, synthetic fibers such as nylon and polyester (e.g., Tetoron), and metal fibers such as stainless wire and nichrome wire. Stainless wire having an outer diameter of 50 to 100 μm is particularly suitable; for it has a tensile strength of 200 gf/wire or greater and an elongation at break of 10% or more and exhibits satisfactory anticorrosion.

The hollow fiber separation membrane can suitably be of materials fit for a mixture to be separated and separation conditions. Suitable materials include elastomeric or glassy polymers, such as polyolefins, polybutadiene, silicone resins, cellulosic polymers, polyamide, polysulfone, polyimide, polyetherimide, polyamideimide, polyether ether ketone, polyphenylene sulfide, polyarylate, and polycarbonate; ceramics, such as zeolite; carbon materials; partially carbonized polymers; rigid polymers such as cardo polyimide; and composites comprising these materials.

The hollow fiber separation membranes to which the present invention is effectively applied are those which have a small elongation and break easily. Because hollow fiber separation membranes having a tensile elongation at break of 0.1 to 10%, particularly 0.1 to 5%, especially 0.1 to 2.5%, are apt to break or rupture, it is not easy to make them into a hollow fiber separation membrane element or module by a process involving bundling-up, adhesion, cutting and the like, and the resulting element or module has poor durability. Since the hollow fiber bunches used in the present invention are reinforced by winding a filament therearound, application of the present invention to such brittle hollow fiber separation membranes makes it possible to easily produce a hollow fiber separation membrane element or a hollow fiber separation membrane module without developing breakage or rupture. The hollow fiber separation membrane element or module according to the present invention has improved durability.

The materials of hollow fiber separation membranes on which the present invention is especially effective when applied include ceramic materials, carbon materials, partially carbonized polymer materials, rigid polymer materials, and composites thereof Hollow fiber separation membranes made of these materials and having a thin wall thickness and a small diameter are very liable to break due to their small elongation.

The structure of the hollow fiber separation membranes can be either symmetric or asymmetric and either porous or non-porous. Asymmetric hollow fiber separation membranes include composite membranes. The hollow fiber separation membrane suitably has a membrane thickness (wall thickness) of 10 to 500 μm and an outer diameter of 50 to 2000 μm.

The hollow fiber bunch (A) preferably has 2 to 50, particularly 2 to 20, hollow fiber separation membranes tied up with the filament.

The hollow fiber separation membrane element is formed by fixing one end or both ends of the hollow fiber bundle (B) through a tubesheet. The number or shape of the tubesheet are not limited. The tubesheet is formed by impregnating the end of the hollow fiber bundle (B) with a curing resin, such as an epoxy resin, an unsaturated polyester resin, a urethane resin or a silicone resin, or a thermoplastic resin, such as polyolefin, polyamide, or fluororesin. If necessary, the impregnating resin is heated or formulated into an emulsion. The resin is hardened by curing, cooling or solvent removal to adhere and fix the end of the bundle (B).

The configuration of the hollow fiber separation membrane element is not particularly limited. An exemplary embodiment is shown in FIG. 2. The element shown in FIG. 2 has a hollow fiber bundle (B) disposed linearly and a tubesheet 3 at each end of the bundle (B). The individual hollow fiber separation membranes 1 pierce each tubesheet 3 and are open to the outside. The hollow fiber bundle (B) is a bundle of large number of hollow fiber bunches (A) each made of five hollow fiber separation membranes 1 gathered and reinforced with a helically wound filament 2. For the sake of simplicity, only nine bunches (A) are depicted in FIG. 2 with other numerous bunches (A) omitted. While not shown in FIG. 2, the hollow fiber separation membrane element can have a core pipe disposed in the center of the bundle (B) in the axial direction, and a film can be provided around the bundle (B). Further, while in FIG. 2 the hollow fiber bunches (A) are straight and bundled up to form a cylindrical hollow fiber bundle (B) (so that the tubesheets are also cylindrical), they can be bundled up into a prism or a flat plate, and the tubesheets can be shaped into a rectangular prism. The hollow fiber bunches (A) can be disposed in a U-shape or helically as well as linearly. The tubesheet is provided at one end or both ends of the hollow fiber bundle (B). One end of the hollow fiber bundle (B) can be closed, in which case the individual hollow fibers may be closed at that end or embedded inside the tubesheet of that end.

The hollow fiber separation membrane module according to the present invention comprises at least one hollow fiber separation membrane element fitted into a container having at least a mixture feed inlet, a permeate discharge outlet, and a residue discharge outlet. The configuration of the module is not particularly limited and includes a bore-side feed type and a shell-side feed type, and a type that does not use a carrier gas or a type that uses a carrier gas. In the type of using a carrier gas, the container additionally has a carrier gas feed inlet, and the element may be provided with a carrier gas feed pipe. A core pipe disposed in the center of the hollow fiber bundle (B) can serve as the carrier gas feed pipe.

The hollow fiber separation membrane module of the present invention can have various configurations according to the shape of the hollow fiber separation membrane element and arrangement of the feed inlet, the permeate discharge outlet, the residue discharge outlet, etc. The module may be cylindrical or box-shaped. In any configuration, the space connecting to the inside of the hollow fiber separation membranes and the space connecting to the outside of the hollow fiber separation membranes should be isolated from each other. A fluid is fed through the feed inlet and introduced to either the inside or the outside of the hollow fiber separation membranes, where it is made to flow in contact with the inner or outer surface of the hollow fiber separation membranes and discharged through the residue discharge outlet. Meanwhile a component selectively passes through the hollow fiber separation membranes into the opposite side (permeate side) of the separation membranes and taken out of the module through the permeate discharge outlet. The container, the core pipe, and other members constructing the module structure are not particularly limited as far as they possess prescribed strength, air tightness, and pressure resistance. They can be made of metal, plastics, fiber-reinforced plastics, ceramics, etc. Adhesives, bolts, nuts, gaskets, etc. can be used where necessary.

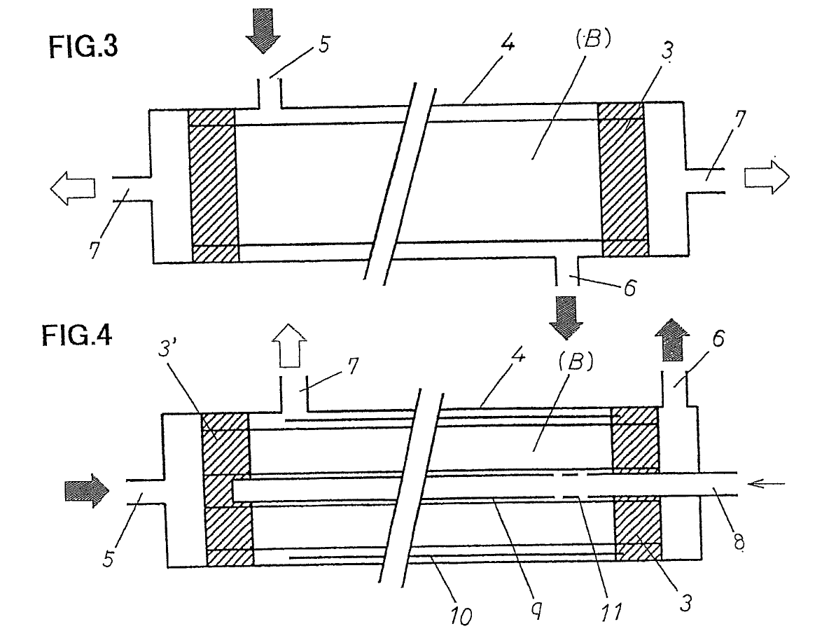

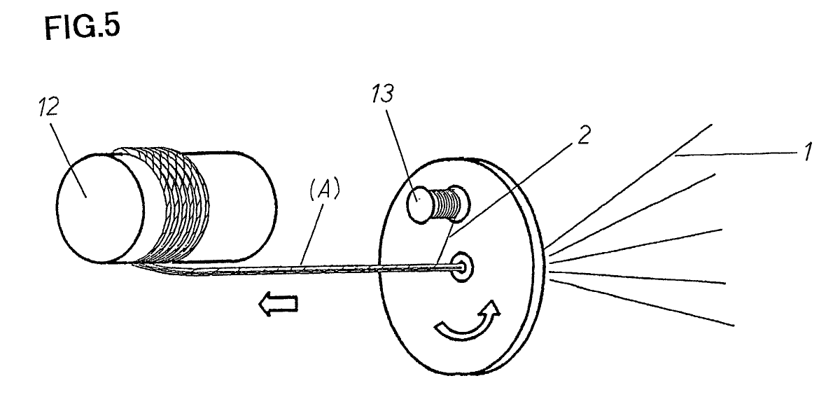

FIG. 3 and FIG. 4 represent a schematic cross-section of embodiments of the hollow fiber separation membrane modules for illustrative purpose but not for limitation. The module shown in FIG. 3 comprises a container 4 having put therein a hollow fiber separation membrane element composed of a hollow fiber bundle (B) and a tubesheet 3. A mixture fed through a feed inlet 5 flows in contact with the outer side of the hollow fiber separation membranes and comes out through a residue discharge outlet 6. The permeate fluid having permeated into the inside of the hollow fiber separation membranes flows inside the separation membranes and comes out from the respective ends opening on the outer sides of the tubesheets 3. The permeate fluid is then taken out of the module through the permeate discharge outlets 7.

In the module shown in FIG. 4, a hollow fiber separation membrane element composed of a hollow fiber bundle (B), a pair of tubesheets 3 and 3′, a core pipe 9, and a film 10 is put in a container 4. A mixture is fed to the outer side of the tubesheet 3′ through a feed inlet 5, enters the hollow fiber separation membranes through their openings open to that side, flows inside the hollow fiber separation membranes, comes out through the openings open to the outer side of the tubesheet 3, and is withdrawn through a residue discharge outlet 6. The core pipe 9 is provided through the center of the hollow fiber bundle (B) in parallel to the hollow fiber separation membranes. One end of the core pipe 9 is buried in the tubesheet 3′, with the other end piercing the tubesheet 3 and the container 4 to form a carrier gas feed inlet 8. Carrier gas supplied through the inlet 8 passes through the core pipe 9 and released through the holes 11 into the space between the two tubesheets where the hollow fiber bundle (B) is disposed. The gas is thus caused to flow countercurrently to the mixture flowing in the hollow fiber separation membranes and is recovered through the permeate discharge outlet 7 together with the permeate. The hollow fiber bundle (B) is wrapped in the film 10.

In FIG. 3 and FIG. 4, the individual hollow fiber bunches (A) making the hollow fiber bundle (B) are not depicted. The arrows in these figures indicate the flow directions of the mixture fed, the residue, the permeate, and the carrier gas.

The hollow fiber separation membrane element and the hollow fiber separation membrane module according to the present invention can be produced by a process comprising the steps of winding a filament around a bunch of hollow fibers to prepare reinforced hollow fiber bunches (A) and bundling a great number of the reinforced hollow fiber bunches (A) to prepare a hollow fiber bundle (B).

Other necessary steps, such as forming a tubesheet, cutting the end of the tubesheet, and putting the hollow fiber separation membrane element in a container can be carried out in a usual manner with no particular restrictions.

The step of making the hollow fiber bunches (A) is not particularly limited, and any technique for winding a filament around a bunch of hollow fibers can be used. An example of the method of continuously helically winding a filament around a bunch of hollow fiber separation membranes will be illustrated with reference to FIG. 5. Five hollow fiber separation membranes 1 are fed from respective feed bobbins (not shown) at the same speed, brought close, made nearly parallel, and forwarded toward a take-up bobbin 12 (or a reeling machine). In the step in which the five hollow fiber separation membranes are brought closer and paralleled to each other, a filament 2 feeder 13 (e.g., a feed bobbin) is revolved about the five hollow fiber separation membranes on a plane perpendicular to the running direction of the hollow fiber separation membranes at a constant revolution speed thereby to wind the filament 2 around the five hollow fiber separation membranes. The hollow fiber bunches (A) helically wound by the filament 2 is taken up around the take-up bobbin 12. In this method, the winding pitch and tension of the filament 2 are adjustable by controlling the running speed of the hollow fiber separation membranes 1 and the revolution speed of the filament 2 feeder 13.

The step of bundling up a great number of the hollow fiber bunches (A) into the hollow fiber bundle (B) is not particularly restricted. A commonly employed method for gathering hollow fibers into a bundle can be adopted. For example, a prescribed number of the hollow fiber bunches (A) are disposed by means of a bundling machine equipped with a traverse guide which reciprocates over a prescribed distance, or the hollow fiber bunch (A) is reeled around a reeling machine to a prescribed number of turns, and the resulting bundle is cut to length.

In the present invention, the tensile strength and the tensile elongation at break were measured with a Tensilon tensile tester (supplied by Orientec) at a pulling speed of 10 mm/min at 23° C. on a specimen having an effective length of 50 mm. The tensile strength is represented by the tensile stress (gf/fiber or filament) at break, and the tensile elongation at break is represented by [(L−L₀)/L₀]×100 (%), wherein L₀ is initial length, and L is length at break.

The present invention will now be illustrated in greater detail with reference to Examples. The following Examples are presented as being exemplary of the present invention and should not be considered as limiting.

### EXAMPLE 1

A partially carbonized polymer membrane having a carbon content of 81.2 wt %, an inner diameter of 190 μm, and an outer diameter of 400 μm, which was obtained by heating an asymmetric polyimide hollow fiber membrane, was used. The hollow fiber separation membrane had a tensile strength of 102 gf/fiber and a tensile elongation at break of 1.8%.

As shown in FIG. 5, five hollow fiber separation membranes were fed close and nearly parallel to each other, and a stainless wire (tensile strength: 302 gf/wire; tensile elongation at break: 40%) having an outer diameter of 80 μm was helically wound at a constant speed around the five separation membranes to obtain a hollow fiber bunch (A), which was wound directly around a reeling machine having a diameter of about 30 cm to a number of turns of 400. The diameter of the stainless wire helix (the diameter of an imaginary cylinder depicted by the helix) was 1.25 mm, and the winding pitch was 5.0 mm, which corresponded to about 63 times the wire diameter. The reeled hollow fiber bunch (A) was removed from the reeling machine and cut to a length of about 920 mm to make a hollow fiber bundle (B) consisting of 400 hollow fiber bunches (A), i.e., 2000 hollow fiber separation membranes. The hollow fiber bundle (B) was wrapped in a 20 μm thick polyimide film to adjust the bundle diameter to 30 mm. After the openings at both ends of the hollow fibers were sealed with an adhesive, both ends of the bundle (B) were impregnated with a liquid epoxy resin, and the resin was cured in a prescribed mold. The ends removed from the mold were cut to expose the openings of the hollow fibers and to regulate the length as specified. The resulting hollow fiber separation membrane element was fitted into a container having a mixture feed inlet, a permeate discharge outlet, and a residue discharge outlet to make a hollow fiber separation membrane module.

A mixed gas of hydrogen and carbon dioxide (50/50 by volume) was treated by the hollow fiber separation membrane module to recover hydrogen having a purity of 99 vol %.

The separation conditions were 50° C. in temperature, 10 kgf/cm² (gauge pressure) in feed pressure, and 2 Nm³/min in feed rate, The amount of the recovered hydrogen (purity: 99 vol %) was 95% or more of the amount of hydrogen (purity: 99 vol %) estimated by calculation from the permeation rate (P′_{H2}, P′_{C02}) and the permeation factor (P′_{H2}/P′_{CO2}) measured by using several hollow fiber separation membranes of the same kind and having no breakage nor rupture under the same conditions, the effective membrane area of the modules, and the like. This indicates that the hollow fiber separation membranes did not undergo breakage nor rupture during the production steps in Example 1.

### Comparative Example 1

A hollow fiber separation membrane module was produced in the same manner as in Example 1, except that the partially carbonized hollow fiber separation membrane was directly reeled around the reeling machine to a number of turns of 2000 without being wound by stainless wire.

A hydrogen/carbon dioxide mixed gas (50/50 by volume) was treated in the resulting separation membrane module under the same conditions as in Example 1, but the module failed to recover 99 vol % pure hydrogen, presumably because breakage or rupture occurred in the hollow fiber separation membranes to let the feed gas leak to the permeate side.

### EXAMPLE 2

A hundred hollow fiber separation membrane modules having the structure of FIG. 3 were produced in the same manner as in Example 1, except that the hollow fiber separation membrane element was made up of 600 hollow fiber separation membranes (120 bunches (A)). No breaks occurred in the hollow fiber separation membranes.

A test was carried out using each of the 100 modules, in which a hydrogen/nitrogen mixed gas (50/50 by volume) was fed from the mixture feed inlet 5 (FIG. 3) to the space outside the hollow fiber separation membranes, and hydrogen was recovered from the inside of the hollow fiber separation membranes. The gas separation performance of the module was measured under conditions of a temperature of 50° C. and a feed pressure of 10 kgf/cm² (gauge pressure). Then 1000 cycles of pressure application and liberation were given to the module, each cycle consisting of 20-second gas feed followed by 5-second gas liberation. Gas separation performance of the module was again measured to find no reduction in performance in all the modules.

### Comparative Example 2

A hundred hollow fiber separation membrane modules having the structure of FIG. 3 were produced in the same manner as in Comparative Example 1, except that the hollow fiber separation membrane element was made up of 600 hollow fiber separation membranes. The modules were inspected for gas leakage by measuring gas separation performance. As a result, only 13 out of 100 were acceptable, having undergone no breakage during production steps. The 13 accepted modules were given 1000 cycles of gas pressure application and liberation in the same manner as in Example 2 and then inspected. It was found that a break occurred in the hollow fiber separation membranes near the mixture feed inlet in all of the 13 modules. In this inspection, the mixed gas was fed at a flow rate of 30 m/sec.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A hollow fiber separation membrane element comprising a bundle of a great number of bunches of hollow fiber separation membranes, said bunches of hollow fiber separation membranes being each reinforced with a filament wound therearound, and a tubesheet provided at one or both ends of said bundle.

2. The hollow fiber separation membrane element according to claim 1, wherein said hollow fiber separation membranes each have a tensile elongation at break of 0.1 to 10%.

3. The hollow fiber separation membrane element according to claim 1, wherein said hollow fiber separation membranes are made of a material selected from the group consisting of ceramic materials, carbon materials, partially carbonized polymer materials, rigid polymer materials, and composites comprising these materials.

4. The hollow fiber separation membrane element according to claim 1, wherein said filament is wound helically.

5. A hollow fiber separation membrane module comprising at least one hollow fiber separation membrane element according to any one of claims 1 to 4 fitted into a container having at least a mixture feed inlet, a permeate discharge outlet, and a residue discharge outlet.

6. A process of producing a hollow fiber separation membrane element and a hollow fiber separation membrane module, which comprises the steps of winding a filament around a bunch of hollow fiber separation membranes to prepare reinforced hollow fiber bunches and bundling a great number of said reinforced hollow fiber bunches.
